(19) United States
(12) Patent Application Publication
(10) Pub. No.: US 2016/0091731 A1
(43) Pub. Date: Mar. 31, 2016

(54) FOLDABLE EYEGLASSES

(71) Applicant: ZHEJIANG HINDAR OPTICAL CO., LTD, Wenzhou City (CN)

(72) Inventor: Shunkao ZHOU, Wenzhou City (CN)

(21) Appl. No.: 14/586,895

(22) Filed: Dec. 30, 2014

(30) Foreign Application Priority Data
Sep. 30, 2014 (CN) 201410521838.5

(51) Int. Cl. G02C 5/08; G02C 5/22; G02C 5/20

(52) U.S. Cl. CPC G02C 5/08; G02C 5/20; G02C 5/22

(57) ABSTRACT

Foldable eyeglasses include a pair of eyeglass rims, a pair of spectacles, and a pair of temples. A first connecting member is provided between the pair of eyeglass rims. Opposing sides of the eyeglass rims are hingedly connected with two ends of the first connecting member through a pair of first hinge shafts which are disposed vertically. The pair of eyeglass rims is foldable inward. The temples each comprise a front section and a rear section. A front end of the front section is hingedly connected with an outer side of a respective one of the eyeglass rims through a second hinge shaft which is vertically disposed. The front section is foldable inward. A rear end of the front section is hingedly connected with a front end of the rear section through a third hinge shaft.

### BACKGROUND OF THE INVENTION

1. Field of the Invention

The present invention relates to eyeglasses, and more particularly to foldable eyeglasses which can be carried conveniently and the spectacles are not worn easily.

2. Description of the Prior Art

Due to congenital reasons or acquired eye unsanitary or age, the refraction system of eyes cannot focus outside images on the retina well, resulting in blurred vision. Therefore, some people have to wear eyeglasses. Eyeglasses become an essential article in daily life for reading. In general, eyeglasses comprise eyeglass rims, a bridge, nose pads, temples, and a hinge mechanism. The eyeglass frame and temples of the existing eyeglasses cannot be folded or are not retractable, so they are large in size. It is inconvenient for carrying. In order to solve this problem, foldable eyeglasses are developed. For example, Chinese patent publication No. CN102262304 published on Nov. 30, 2011, titled “glasses”, discloses foldable eyeglasses. The foldable eyeglasses provide pins between the eyeglass rims, at two sides of the eyeglass rims, and at the middle of the temples to constitute a foldable mechanism. The two sides of the eyeglass rims are provided with spiral sleeves for connecting the two temples. Through this structure, the eyeglasses are foldable and detachable. Thus, they can be stored and carried conveniently. But, the temples are located between the two eyeglass rims after the eyeglasses are folded. The outer surfaces of the spectacles are worn and damaged easily. It is necessary to put the eyeglasses into an eyeglass case for storage or portability. Accordingly, the inventor of the present invention has devoted himself based on his many years of practical experiences to solve these problems.

### SUMMARY OF THE INVENTION

The primary object of the present invention is to provide foldable eyeglasses which can be carried conveniently and the spectacles won't be worn easily.

In order to achieve the aforesaid object, the foldable eyeglasses of the present invention comprise a pair of eyeglass rims, a pair of spectacles, and a pair of temples. A first connecting member is provided between the pair of eyeglass rims. Two opposing sides of the pair of eyeglass rims are hingedly connected with two ends of the first connecting member through a pair of first hinge shafts which are disposed vertically. The pair of eyeglass rims is foldable inward. The temples each comprise a front section and a rear section. A front is end of the front section is hingedly connected with an outer side of a respective one of the eyeglass rims through a second hinge shaft which is vertically disposed. The front section is foldable inward. A rear end of the front section is hingedly connected with a front end of the rear section through a third hinge shaft. The third hinge shaft is transversely disposed.

Preferably, the first connecting member has a bar platy shape. The opposing sides of the pair of eyeglass rims are provided with hinge seats. A hinge end of each hinge seat has a level groove corresponding in position to the first connecting member. The two ends of the first connecting member are received in the level grooves of the hinge seats and hinged by the first hinge shafts. The hinge seats each have a curved corner at an outer side thereof and a right corner at an inner side thereof to be folded outward.

Preferably, the foldable eyeglasses further comprise a second connecting member. The rear end of the front section and the front end of the rear section each have a vertical groove corresponding in position to the second connecting member. Two ends of the second connecting member are received in the vertical grooves at the rear end of the front section and the front end of the rear section. The two ends of the second connecting member are foldable through the third hinge shaft.

Preferably, the front section and the rear section each have a platy shape and a length greater than a transverse size of the eyeglass rims.

The eyeglass rims of the foldable eyeglasses are folded outward. The outer surfaces of the spectacles are face to face. The front sections and the rear sections of the temples are folded to be located at the outer sides of the is inner surfaces of the spectacles. The eyeglasses are folded in an M shape. The size of the eyeglasses is reduced greatly for easy portability. The inner and outer surfaces of the spectacles can be protected, preventing the surfaces of the spectacles from be worn. There is no need to carry an eyeglass case.

### BRIEF DESCRIPTION OF THE DRAWINGS

FIG. 1 is a perspective view according to a preferred embodiment of the present invention;

FIG. 2 is another perspective view according to the preferred embodiment of the present invention;

FIG. 3 is an enlarged view of circle I of FIG. 1;

FIG. 4 is an enlarged view of circle II of FIG. 2;

FIG. 5 is a schematic view showing the preferred embodiment of the present invention in a semi folded state;

FIG. 6 is a schematic view showing the preferred embodiment of the present invention in a folded state;

FIG. 7 is another schematic view showing the preferred embodiment of the present invention in a folded state; and

FIG. 8 is a further perspective view according to the preferred embodiment of the present invention.

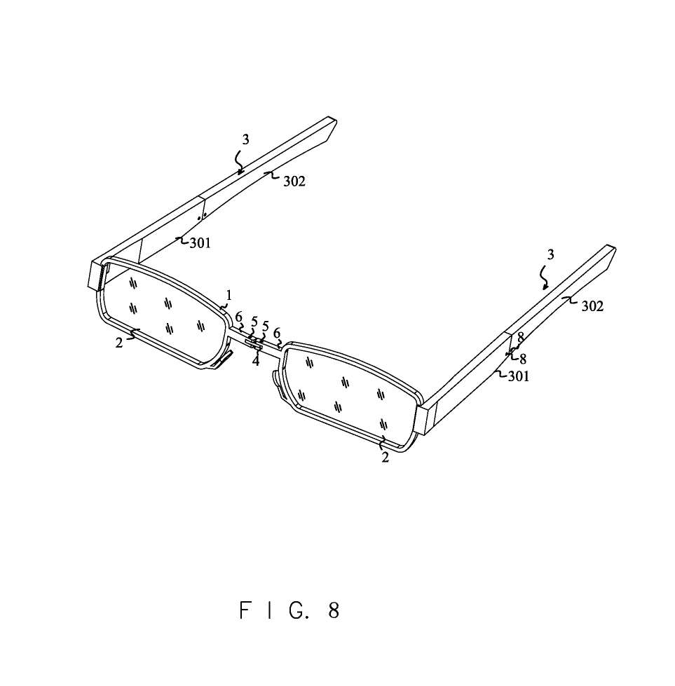

### DETAILED DESCRIPTION OF THE PREFERRED EMBODIMENTS

Embodiments of the present invention will now be described, by way of example only, with reference to the accompanying drawings.

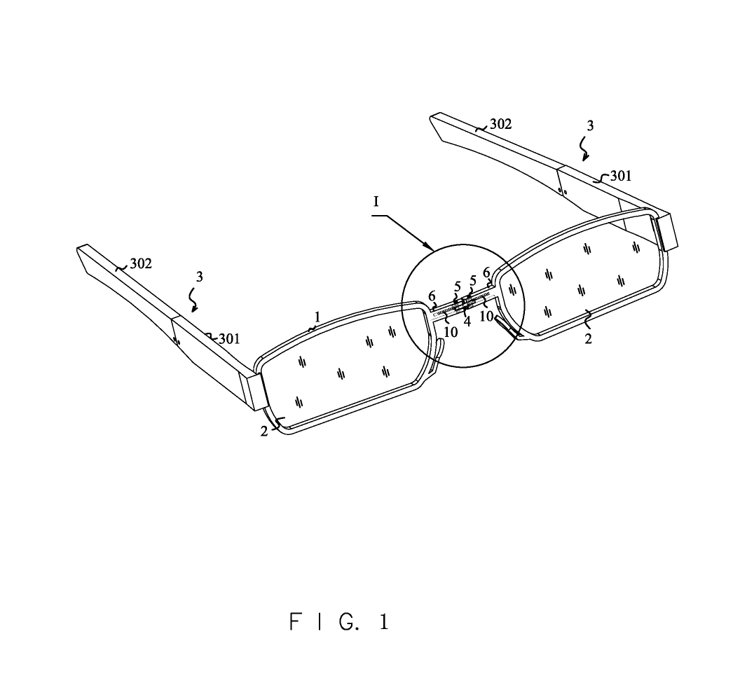

The present invention is applied to full rim eyeglasses, semi rimless eyeglasses, or rimless eyeglasses. In this embodiment, full rim eyeglasses are as example. As shown in FIG. 1, the foldable eyeglasses comprise a pair of eyeglass rims 1, a pair of spectacles 2, and a pair of temples 3. The spectacles 2 are installed on the eyeglass rims 1. The shapes of the spectacles 2 and the eyeglass rims 1 can be designed as desired.

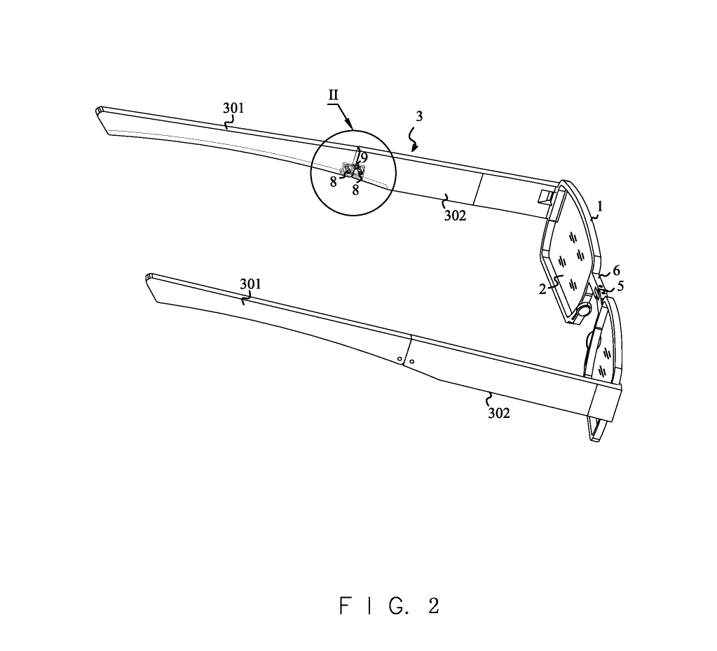

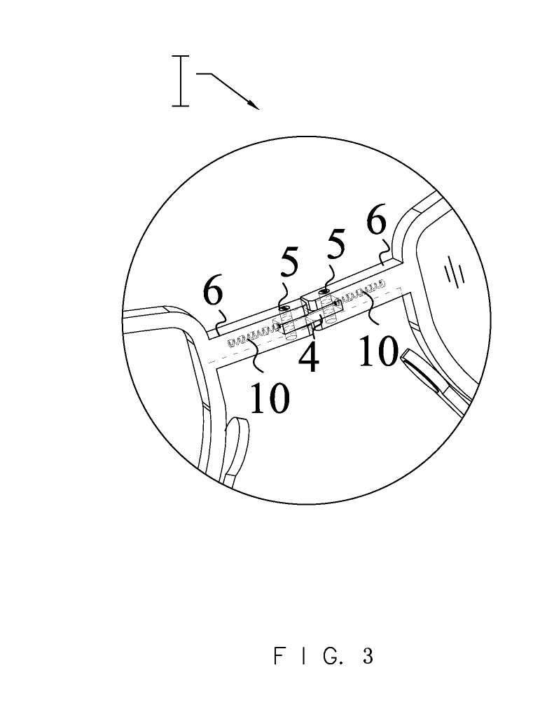

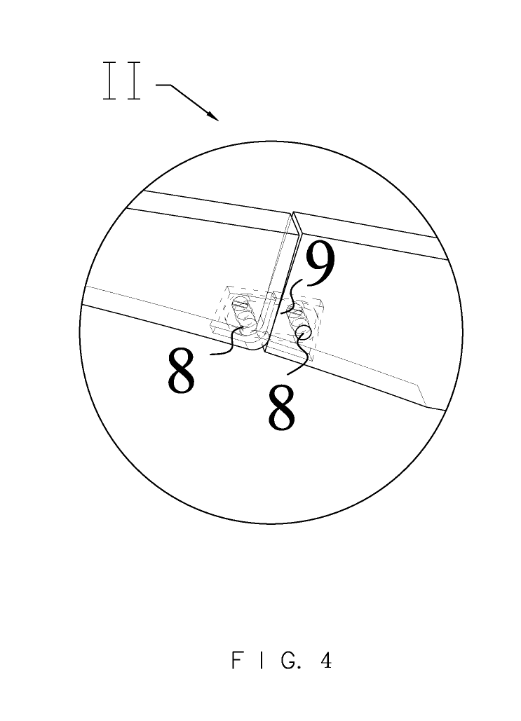

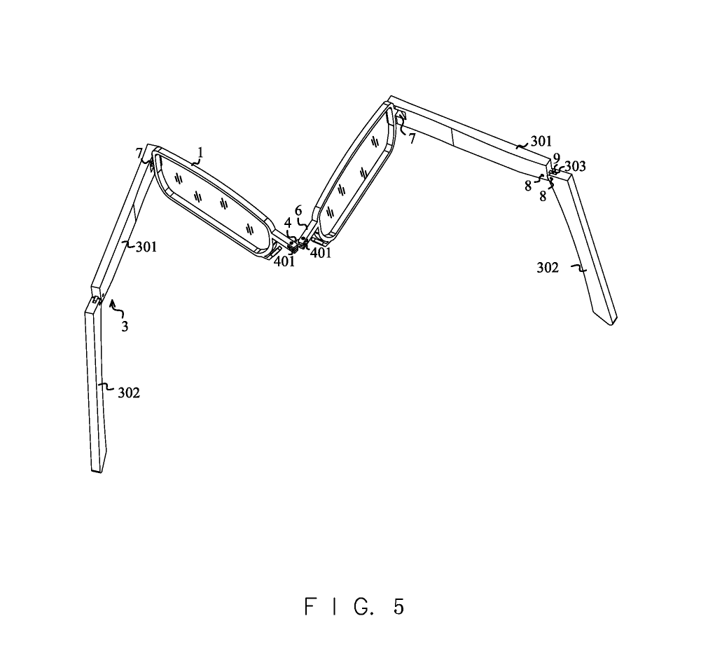

As shown in FIG. 1 to FIG. 5, a first connecting member 4 is provided between the pair of eyeglass rims 1. Two opposing sides of the pair of eyeglass rims 1 are hingedly connected with two ends of the first connecting member 4 through a pair of first hinge shafts 5 which are disposed vertically, respectively. The pair of eyeglass rims 1 can be folded inward. The first hinge shafts 5 are disposed vertically for the pair of spectacles 2 to be folded face to face. The first connecting member 4 disposed between the pair of eyeglass rims 1 can prevent the spectacles 2 from colliding with each other after the spectacles 2 are folded face to face. In this embodiment, the first connecting member 4 preferably has a bar platy shape. The opposing sides of the pair of eyeglass rims 1 are provided with hinge seats 6. One end of each hinge seat 6 is fixedly connected with a respective one of the eyeglass rims 1, and another end of each hinge seat 6 is a hinge end. The hinge end of each hinge seat 6 has a level groove 401 corresponding in position to the first connecting member 4. The two ends of the first connecting member 4 are received in the level grooves 401 of the hinge seats 6. The two ends of the first connecting member 4 are hinged by the first hinge shafts 5. Preferably, a spring 10 is provided in the level groove 401. The respective ends of the springs 10 in the two hinge seats 6 are against the two ends of the first connecting member 4. The hinge end of each hinge seat 6 has a curved corner at an outer side thereof and a right corner at an inner side thereof, such that the hinge seats 6 are folded outward, not inward. The temples 3 each comprises a front section 301 and a rear section 302. A front end of the front section 301 is hingedly connected with an outer side of a respective one of the eyeglass rims 1 through a second hinge shaft 7 which is vertically disposed. The front section 301 can be folded in an outward direction. A rear end of the front section 301 is hingedly connected with a front end of the rear section 302 through a third hinge shaft 8. The third hinge shaft 8 is transversely disposed. Preferably, a second connecting member 9 is provided between the rear end of the front section 301 and the front end of the rear section 302. The rear end of the front section 301 and the front end of the rear section 302 each have a vertical groove 303 corresponding in position to the second connecting member 9. Two ends of the second connecting member 9 are received in the vertical grooves 303 at the rear end of the front section 301 and the front end of the rear section 302. The two ends of the second connecting member 9 can be folded through the third hinge shaft 8. In order to protect the spectacles 2, the front section 301 and the rear section 302 preferably have a platy shape and a length greater than a transverse size of the eyeglass rims 1, providing a larger range to protect the spectacles 2.

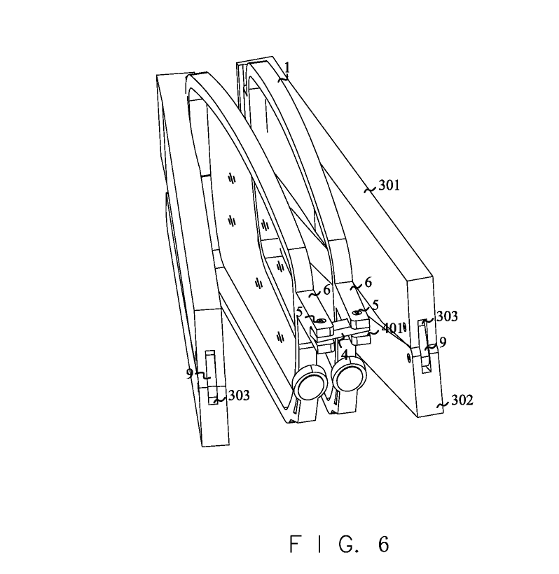

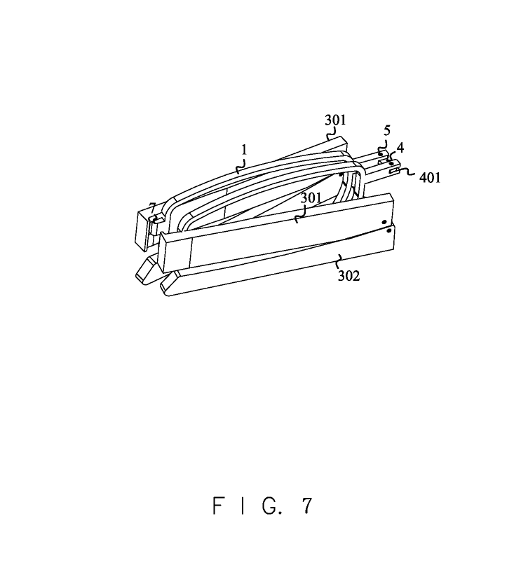

As shown in FIG. 6 and FIG. 7, the eyeglass rims 1 of the foldable eyeglasses are folded outward. The outer surfaces of the spectacles 2 are face to face. The front sections 301 and the rear sections 302 of the temples 3 is are folded to be located at the outer sides of the inner surfaces of the spectacles 2. The eyeglasses are folded in an M shape. The size of the eyeglasses is reduced greatly for easy portability. The inner and outer surfaces of the spectacles 2 can be protected, preventing the surfaces of the spectacles 2 from be worn. There is no need to carry an eyeglass case.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. Foldable eyeglasses, comprising a pair of eyeglass rims, a pair of spectacles, and a pair of temples, a first connecting member being provided between the pair of eyeglass rims, two opposing sides of the pair of eyeglass rims being hingedly connected with two ends of the first connecting member through a pair of first hinge shafts which are disposed vertically, the pair of eyeglass rims being foldable inward; the temples each comprising a front section and a rear section, a front end of the front section being hingedly connected with an outer side of a respective one of the eyeglass rims through a second hinge shaft which is vertically disposed, the front section being foldable inward; a rear end of the front section being hingedly connected with a front end of the rear section through a third hinge shaft, the third hinge shaft being transversely disposed.

2. The foldable eyeglasses as claimed in claim 1, wherein the first connecting member has a bar platy shape, the opposing sides of the pair of eyeglass rims being provided with hinge seats, a hinge end of each hinge seat having a level groove corresponding in position to the first connecting member, the two ends of the first connecting member being received in the level grooves of the hinge seats and hinged by the first hinge shafts, the hinge seats each having a curved corner at an outer side thereof and a right corner at an inner side thereof to be folded outward.

3. The foldable eyeglasses as claimed in claim 2, further comprising a second connecting member, the rear end of the front section and the front end of the rear section each having a vertical groove corresponding in position to the second connecting member, two ends of the second connecting member being received in the vertical grooves at the rear end of the front section and the front end of the rear section, the two ends of the second connecting member being foldable through the third hinge shaft.

4. The foldable eyeglasses as claimed in claim 3, wherein the front section and the rear section each have a platy shape and a length greater than a transverse size of the eyeglass rims.
